(19) United States
(12) Patent Application Publication
(10) Pub. No.: US 2024/0142259 A1
(43) Pub. Date: May 2, 2024

(54) SYSTEM AND METHOD FOR RISKY ROAD CONDITION WARNING

(71) Applicant: HERE Global B.V., Eindhoven (NL)

(72) Inventor: Donta WHITE, Racine, WI (US)

(21) Appl. No.: 17/978,706

(22) Filed: Nov. 1, 2022

(51) Int. Cl. G01C 21/00; G01C 21/34

(52) U.S. Cl. CPC G01C 21/3815; G01C 21/3461; G01C 21/3859

(57) ABSTRACT

A system, a method, and a computer program product may be provided for risky road condition warning. The system may include a memory configured to store computer executable instructions and a processor configured to execute the computer executable instructions to obtain a set of vehicle features associated with a dispensing vehicle travelling along a link. The processor is configured to determine a set of risk-related features associated with the link based at least on the set of vehicle features. The processor is configured to obtain map data associated with the link. The processor is configured to determine a risk value for the link based on the set of risk-related features and the map data, and update a map database associated with the link based on the risk value.

### TECHNOLOGICAL FIELD

The present disclosure generally relates to risk warning, and more particularly relates to warning for risky road conditions due to dispensing vehicles.

### BACKGROUND

Vehicles, such as carrier vehicles or transport vehicles are used for transportation of goods from one place to another via a road network. For example, the vehicles may be used for transportation of sand, gravel, salt, rock, agricultural produce, construction materials, waste material from construction sites, furniture, furniture waste, and so forth. During the transportation of goods, certain visible or non-visible debris and particles may fall off or get dispensed from the vehicles.

In certain cases, a vehicle that may be behind such vehicles (referred to as dispensing vehicle, hereinafter) that dispense debris and particles or vehicles that may travel on a link previously travelled by the dispensing vehicles may encounter the debris and particles that may fall from the dispensing vehicles. This may affect driving conditions or road conditions. As a result, vehicle owners may face problems, such as risky and unsafe driving conditions, and affected physical condition of vehicle, for example, when debris hits the vehicle. Therefore, solution to the above problem caused due to dispensing vehicles is required.

### BRIEF SUMMARY

A system, a method, and a computer program product are provided herein that provides risky road condition warning. In one aspect, the system for risky road condition warning may be provided. The system may include a memory configured to store computer executable instructions; and one or more processors (hereinafter referred as processor) configured to execute the instructions to obtain a set of vehicle features associated with a dispensing vehicle travelling along a link. In accordance with an embodiment, the processor may be configured to determine a set of risk-related features associated with the link based at least on the set of vehicle features. In accordance with an embodiment, the processor may be configured to obtain map data associated with the link. In accordance with an embodiment, the processor may be configured to determine a risk value for the link based on the set of risk-related features and the map data and update a map database associated with the link based on the risk value.

According to some example embodiments, the processor is further configured to update navigation instructions for travelling on the link based on the risk value.

According to some example embodiments, the processor is further configured to dynamically determine a risk value for one or more points on the link at predetermined intervals of time based on the set of risk-related features and the map data associated with the link and update the navigation instructions based on the risk value of the one or more points on the link.

According to some example embodiments, the updated navigation instructions include at least one of: an alternative link recommendation or a risk warning message for travelling on the link, when the risk value is more than a predefined threshold.

According to some example embodiments, the set of vehicle features associated with the dispensing vehicle includes at least one of: a travel route of the dispensing vehicle, dimensions associated with a dispensing opening of the dispensing vehicle, total load of particles carried by the dispensing vehicle, a rate of dispensing of particles through the dispensing opening, or time of travel of the dispensing vehicle.

According to some example embodiments, the set of vehicle features associated with the dispensing vehicle is determined based on tracking of the dispensing vehicle.

According to some example embodiments, the tracking of the dispensing vehicle is performed based on at least one of: vehicles travelling along the travel route of the dispensing vehicle, or metadata provided by a third-party server associated with the dispensing vehicle.

According to some example embodiments, the processor is further configured to obtain environment data associated with the link, wherein the environment data includes environmental effect on dispensed particles from the dispensing vehicle, and determine the risk value for the link based on the set of risk-related features, the map data, and the environment data.

According to some example embodiments, the map data includes at least one of: link geometry, speed limit, intersections information, or link conditions.

According to some example embodiments, the set of risk-related features associated with the link includes at least one of: change in a road condition parameter due to particles dispensed by the dispensing vehicle, change in a driving condition parameter due to the particles dispensed by the dispensing vehicle, or an impact parameter associated with impact of the particles dispensed by the dispensing vehicle on a vehicle on the link.

Embodiments disclosed herein may provide a method for risky road condition warning. The method may include obtaining a set of vehicle features associated with a dispensing vehicle travelling along a link. The method may include determining a set of risk-related features associated with the link based at least on the set of vehicle features. The method may include obtaining map data associated with the link. The method may include determining a risk value for the link based on the set of risk-related features and the map data. The method may include updating a map database associated with the link, based on the risk value.

According to some example embodiments, the method may further include updating navigation instructions for travelling on the link based on the risk value.

According to some example embodiments, the method may further include dynamically determining a risk value for one or more points on the link at predetermined intervals of time, based on the set of risk-related features and the map data associated with the link. The method may further include updating the navigation instructions based on the risk value of the one or more points on the link.

According to some example embodiments, the updated navigation instructions include at least one of: an alternative link recommendation or a risk warning message for travelling on the link, when the risk value is more than a predefined threshold.

According to some example embodiments, the method may further include obtaining environment data associated with the link, wherein the environment data includes environmental effect on dispensed particles from the dispensing vehicle. The method may further include determining the risk value for the link, based on the set of risk-related features, the map data, and the environment data.

According to some example embodiments, the set of vehicle features associated with the dispensing vehicle includes at least one of: a travel route of the dispensing vehicle, dimensions associated with a dispensing opening of the dispensing vehicle, total load of particles carried by the dispensing vehicle, a rate of dispensing of particles through the dispensing opening, or time of travel of the dispensing vehicle.

According to some example embodiments, the map data includes at least one of: link geometry, speed limit, intersections information, or link conditions.

According to some example embodiments, the set of risk-related features associated with the link includes at least one of: change in a road condition parameter due to particles dispensed by the dispensing vehicle, change in a driving condition parameter due to the particles dispensed by the dispensing vehicle, or an impact parameter associated with impact of the particles dispensed by the dispensing vehicle on a vehicle on the link

Embodiments of the present disclosure may provide a computer programmable product including a non-transitory computer-readable medium having stored thereon computer-executable instructions, which when executed by one or more processors, because the one or more processors to carry out operations for risky road condition warning. The operations include obtaining a set of vehicle features associated with a dispensing vehicle travelling along a link. The operations include determining a set of risk-related features associated with the link based at least on the set of vehicle features. The operations include obtaining map data associated with the link. The operations include determining a risk value for the link based on the set of risk-related features and the map data. The operations include updating a map database associated with the link, based on the risk value.

According to some example embodiments, the operations may further include updating navigation instructions for travelling on the link based on the risk value.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a network environment within which a system for risky road condition warning is implemented, in accordance with an example embodiment;

FIG. 2 illustrates a block diagram of a system for providing risky road condition warning, in accordance with an example embodiment;

FIG. 3 shows an exemplar environment where a risk value for a link is calculated, in accordance with an example embodiment;

FIG. 4 illustrates a flowchart of a method for determining risk value for a link, in accordance with an example embodiment;

FIG. 5 illustrates a flowchart of a method for generating navigation instructions based on risk value of a link, in accordance with an example embodiment;

FIG. 6A illustrates an exemplar format of map data stored in a map database in accordance with an example embodiment;

FIG. 6B illustrates another exemplar format of the map data stored in the map database, in accordance with an example embodiment; and

FIG. 6C illustrates an exemplar map database storing map data for providing risky road condition warning, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road” may refer to a way leading a traveler from one location to another. The road may have a single lane or multiple lanes.

The term “lane” may refer to a part of a road that is designated for travel of vehicles or pedestrians as per some condition.

The term “link” may refer to any connecting pathway including, but not limited, to a roadway, a highway, a freeway, an expressway, a lane, a street path, a road, an alley, a controlled access roadway, a free access roadway and the like.

The term “route” may refer to a planned or a developed path that may be used by a vehicle to reach from one point or a source location to another point or a destination location. The route may include, for example, roads, lanes, links, air space, and so forth.

The term “navigation instructions” may refer to one or more set of instructions for navigating from a source location to a destination location. For example, the navigation instructions may indicate one or more instructions depending on different transport vehicle options, such as private and public transport vehicles. The navigation instructions may also indicate a best possible way for travelling from the source location to the destination location depending on, for example, traffic conditions, road conditions, public vehicle options, private vehicle options, and so forth. In an example, the navigation instructions may also include textual instructions with all relevant navigation information, one or more flow or incident routing messages or alerts, estimated time of arrival (ETA) at the destination location, distance to travel, map icons, traffic information along the route, and other settings and route-related information.

The term “risky road condition” may refer to a road condition that may correspond to a risky state of a road, such that it poses a risk or threat to users and vehicles alike travelling through, on or in vicinity of the road. In an example, the risky road condition may be caused presence of foreign elements, for example, particles, debris, and so forth, on the road. Subsequently, the risky road condition may cause unsafe driving conditions on the road. In an embodiment, an occurrence of the risky road condition may make it difficult to drive for drivers in certain areas, such as certain part or parts of the road network and/or may cause any damage to vehicle.

For the embodiments described herein, the term “cargo” refers to all types of items and/or goods suitable for transport or carrying by a transport vehicle, which may be carried by a dispensing vehicle. By way of an example, the dispensing vehicle may be tasked to deliver or dispense cargo.

The term “particles” may refer to visible or a collection of non-visible matter that may affect driving condition. In an example, the particle may be an object or an article.

Throughout the present disclosure, the term “dispensing vehicle” may refer to a transport vehicle that may haul or carry goods. In an example, the dispensing vehicle may have at least one cargo bed for carrying the good and an engine. For example, the dispensing vehicle may be an autonomous, semi-autonomous, or manually-operated vehicle. The dispensing vehicle may have the cargo bed and at least one opening to put or remove goods from inside of the cargo bed. Examples of the dispensing vehicle may include, but are not limited to, lorry, truck, tractor truck, pickup truck, trailer truck, mini truck, tow truck, carrier truck, tipper or dumper trailer, and mixer truck. In an example, the dispensing vehicle is a salt dispensing truck or tractor-trailer. In this regard, the salt dispensing vehicle my dispense salt to cause melting of snow on a link.

### End of Definitions

A system, a method, and a computer program product are provided herein in accordance with an example embodiment for risky road condition warning. The system, the method, and the computer program product disclosed herein enables determination of a risk associated with a link due to particles dispersed on the link, while travelling on the link. Specifically, the system, the method, and the computer program product disclosed herein prevent vehicles travelling on a link from encountering particles dispersed by the dispensing vehicle, and prevent driver of vehicles from facing effect, such as slippery road, corrosion of vehicle, etc., of the dispersed particles while driving.

The system, the method, and the computer program product disclosed herein may be configured to provide an alternative link recommendation or a risk warning in case of risky road condition on a link. This may enable the driver to take informed decision and avoid risky roads. The system, the method, and the computer program product disclosed herein may be configured to determine and provide risk assessment (referred to as risk value) of a link, based on historical and real-time information relating to a dispensing vehicle that dispenses certain particles on the link as well as information relating to geometry and topography of the link. For example, such risk value may be provided to a driver of a vehicle, such as via a user equipment associated with the driver or the vehicle, through navigation instructions, notifications, in-app notifications, messages, prompts and so forth. In an example, the system, the method, and the computer program product disclosed herein may be configured to identify and provide information associated with particles dispensed by a dispensing vehicle, and impact of such particles on driving conditions.

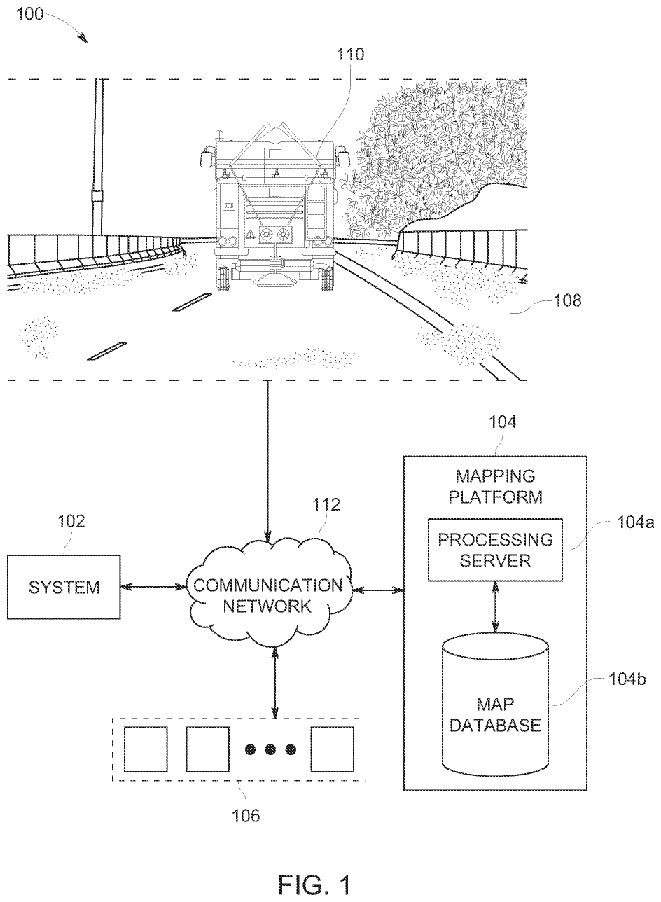

FIG. 1 illustrates a network environment 100 within which a system 102 for risky road condition warning is implemented, according to some embodiments. As shown in FIG. 1, the network environment 100 may include the system 102, and a mapping platform 104. The mapping platform 104 may further include a processing server 104a and a map database 104b. The network environment 100 may further include vehicles 106, a link 108, a dispensing vehicle 110 and a network 112. The vehicles 106 may include one or more sensors, user equipment and/or a communication interface (not shown in the FIG. 1).

The dispensing vehicle 110 may hold goods within a cargo bed. The dispensing vehicle may also have a dispensing opening to dispense some particles. In accordance with an example, the dispensing vehicle 110 may be a pickup truck carrying salt. Further, the dispensing vehicle 110 may dispense salt on road segments or links, such as the link 108, through the dispensing opening. For example, the dispensing vehicle 110 for dispensing salt may be commissioned by a local authority, such as a municipality, for clearing snow from the link 108 during winters. During transportation of goods, the goods may be kept and removed from the dispensing vehicle 110 through one or more openings, for example, a top opening, and a rear opening. In certain cases, the one or more openings of the dispensing vehicle 110 may not be covered, i.e., open from top. For example, the dispensing vehicle 110 carrying salt may dispense salt also from the one or more openings other than the dispensing opening. To this end, the dispensing vehicle 110 may dispense salt particles while moving.

In an example, when a vehicle, for example, one of the vehicles 106, comes in contact with particles dispensed from the dispensing vehicle 110, it may experience certain impact. For example, depending on nature, type, weight, etc. of particles or object dispensed from the dispensing vehicle 110, minor or major damage may occur to a vehicle. In an example, the dispensing vehicle 110 carrying salt may dispense salt particles based on weather predictions. For example, the dispensing vehicle 110 may dispense salt two hours before a predicted time of snowfall to cause snow to melt and prevent obstruction of roads.

However, due to dispensing of salt, risky road conditions may be created on the road on which the dispensing vehicle 110 dispenses the salt particles. For example, when salt particles are dispensed on clear road (before the snowfall), the salt particles may gain a projectile from vehicles moving on the road. Further, the salt particles may get in contact with the outer body of the vehicles moving on the road. To this end, such encounter of the outer body of the vehicles with the salt particles may damage the body, such as chassis, windshield, etc., of the vehicles. Further, when the salt particles are dispensed on the road, they may cause slippery road condition, specifically on turns or turnarounds. This might affect a driver's ability to control a vehicle, causing risky road condition for the driver and those within proximity.

Pursuant to embodiments of the present disclosure, techniques for assessing risk associated with a link, specifically, risk caused due to particles dispensed from the dispensing vehicle 110 is disclosed.

To address the above-stated technical challenges, the system 102 of FIG. 1 introduces a capability to determine whether travelling on the link 108 after the travel of dispensing vehicle 110 will be safe or not.

In accordance with an embodiment, the mapping platform 104 may comprise suitable logic, circuitry, and interfaces that may be configured to store one or more map attributes associated with road network. The mapping platform 104 may be configured to store and update map data indicating the map attributes, in the map database 104b. The mapping platform 104 may use techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 104 may be collected using a plurality of technologies including, but not limited to drones, sensors, connected cars, cameras, probes, and chipsets. In some embodiments, the mapping platform 104 may be embodied as a chip or chip set. In other words, the mapping platform 104 may comprise one or more physical packages (such as, chips) that includes materials, components and/or wires on a structural assembly (such as, a baseboard).

In some example embodiments, the mapping platform 104 may include the processing server 104a for carrying out the processing functions associated with the mapping platform 104 and the map database 104b for storing map data and other data, such as a set of vehicle features associated with the dispensing vehicle 110. In an embodiment, the processing server 104a may comprise one or more processors configured to process requests received from the system 102. The processors may fetch the set of vehicle features associated with the dispensing vehicle 110 and/or the map data from the map database 104b and transmit the same to the system 102 in a format suitable for use by the system 102. In some example embodiments, as disclosed in conjunction with the various embodiments disclosed herein, the system 102 may be used to process the set of vehicle features associated with the dispensing vehicle 110 and the map data for identifying a risky road condition due to particles dispensed by the dispensing vehicle 110. The system 102 may also generate navigation instructions based on identifying the risky road condition.

Continuing further, the map database 104b may comprise suitable logic, circuitry, and interfaces that may be configured to store the map data and other data, such as the set of vehicle features associated with the dispensing vehicle 110, which may be collected from vehicles 106 traveling on the link 108 on a route, or on another link associated with the dispensing vehicle 110. In an example, the mapping platform 104 may receive the data from the vehicles 106 and fuse the received data with map data to infer risk value and road conditions associated with the link 108 in which probes or fleeting vehicles 106 and the dispensing vehicle 110 are moving. In accordance with an embodiment, such data received from the vehicles 106 may be updated in real time or near real time such as within a few seconds, a few minutes, or on hourly basis, to provide accurate and up to date data. The data may be collected from any sensor on-board the vehicles 106, such that the data comprises information, such as area of operation, time of operation, geolocation, etc. relating to the dispensing vehicle 110. For example, motion sensors, inertia sensors, vehicle condition sensors, image capture sensors, proximity sensors, LIDAR (light detection and ranging) sensors, and ultrasonic sensors may be used to collect the event data.

For example, the data stored in the map database 104b may be compiled (such as into a platform specification format (PSF)) to organize and/or processed for identifying risky road conditions associated with a link and generate or update navigation-related functions and/or services, such as route calculation, route guidance, speed calculation, distance and travel time functions, navigation instruction, and other functions, by a navigation device, such as a UE. The navigation-related functions may correspond to navigation from a source to a destination through the link 108 or an alternative link associated with the link 108. The compilation to produce the end user databases may be performed by a party or entity separate from the map developer. For example, a customer of the map developer, such as a navigation device developer or other end user device developer, may perform compilation on a received map database 104b in a delivery format to produce one or more compiled navigation databases.

In some embodiments, the map database 104b may be a master database configured on the side of the system 102. In accordance with an embodiment, a client-side map database may represent a compiled navigation database that may be used in or with end user devices (e.g., user equipment associated with the vehicles 106) to provide navigation instructions, and/or map-related functions to navigate through to the link 108.

In operation, the system 102 may obtain a set of vehicle features associated with the dispensing vehicle 110 travelling along the link 108. In an example, the set of vehicle features associated with the dispensing vehicle 110 may be determined based on tracking of the dispensing vehicle 110. In an example, the tracking of the dispensing vehicle 110 may be performed based on vehicles 106 travelling along a travel route of the dispensing vehicle 110, such as on the link 108, or metadata provided by a third-party server associated with the dispensing vehicle 110. In particular, the vehicles 106 may be travelling along a travel route of the dispensing vehicle 110, or a part of the travel route. For example, the vehicles 106 may travel on the link 108, on which the dispensing vehicle 110 has travelled or is travelling. To this end, the vehicles 106 may experience same or different effects of particles dispensed from the dispensing vehicle 110. In an example, the particles may be salt particles or salt pellets.

In an example, the system 102 may obtain the set of vehicle features from the vehicles 106 directly. In another example, the vehicles 106 may transmit the data to the mapping platform 104. In such a case, the system 102 may query the mapping platform 104 to retrieve the set of vehicle features. In an example, the set of vehicle features may include tracking information relating to the dispensing vehicle 110, travel route of the dispensing vehicle 110, rate of dispensing particles by the dispensing vehicle, etc.

In some example embodiments, the vehicles 106 may generate sensor data on detecting dispensing vehicle 110 in vicinity, particles being dispensed by the dispensing vehicle 110, or certain hazardous or anomalous conditions. In accordance with an embodiment, the sensor data may be generated by the vehicles 106, when sensor(s) on-board the vehicles 106 may sense that anomalous conditions are met or satisfied. In accordance with an embodiment, the anomalous conditions may be pre-defined based on, for example, low or reduced visibility, accidents, broke down vehicles, slippery road, or physical damage to vehicles. In accordance with an embodiment, the sensor data may be generated by the vehicles 106, when sensor(s) on-board the vehicles 106 may sense that a dispensing vehicle is in proximity to vehicles, for example, based on identifying certain physical parameters associated with the dispensing vehicle 110. The physical parameters may include, for example, size of vehicle, emissions by the vehicle, size of a dispensing opening, and type of vehicle. The vehicles 106 may generate the sensor data in real-time and transmit it to the system 102 and/or the mapping platform 104 to report the anomalous condition. In certain cases, the vehicles 106 may be configured to send updated sensor data periodically, for example, every five seconds, every thirty seconds, every minute, and so forth, in case where detection of anomalous conditions persists. Such sensor data received from the vehicles 106 may be stored as the set of vehicle features associated with the dispensing vehicle 110.

In some example embodiments, the system 102 may obtain the set of vehicle features associated with the dispensing vehicle 110 from metadata provided by a third-party server associated with the dispensing vehicle 110. For example, the third-party server may be associated with an organization that operates the dispensing vehicle 110. Examples of the organization may include, but are not limited to, a municipality, a private or semi-private contractor associated with the municipality, a transportation service provider, moving or shipping service providers, and a carrier service provider.

Continuing further, the system 102 may determine a set of risk-related features associated with the link 108 based at least on the set of vehicle features. In an example, the system 102 may identify features from the set of vehicle features that would impact road condition and driving conditions on the link 108. In an example, the system 102 may assess an amount and a type of particles dispensed by the dispensing vehicle 110 and impact of the dispensed particles on driving conditions and road conditions on the link 108. In an example, the set of risk-related features associated with the link 108 includes at least one of change in a road condition parameter due to particles dispensed by the dispensing vehicle 110, change in a driving condition parameter due to the particles dispensed by the dispensing vehicle 110, or an impact parameter of impact of the particles dispensed by the dispensing vehicle 110 on a vehicle on the link 108.

The system 102 may obtain map data associated with the link 108. The map data may be obtained by querying the mapping platform 104 or the map database 104b of the mapping platform 104. For example, the map data may include at least one of link geometry, speed limit, intersections information, or link conditions. In an example, the link geometry may indicate construction, for example, width, length, height, area of curved path, type of curve, area of straight path, lanes, etc., of the link 108. In an example, the speed limit may indicate speed limit for different kinds of vehicles for travelling on the link 108. The intersections information may indicate intersection data, such as condition of intersection, type of intersection, condition of different links after intersection, traffic at intersection, etc. associated with intersections of the link 108. Further, the link conditions may indicate, for example, condition of the link 108, such as condition of surface of the link 108, condition of side drain, surface potholes, link shape, vegetation around the link 108, etc.

Thereafter, the system 102 may determine a risk value for the link 108 based on the set of risk-related features and the map data. The system 102 may then store the risk value in the map database 104b. In this regard, the system 102 may fuse the risk-related features indicating impact of particles dispensed from the dispensing vehicle 110 with the map data indicating surface condition of the link 108 to infer the risk value associated with driving on the link 108.

Pursuant to present disclosure, the system 102 may identify the dispensing vehicle 110 to be dispensing salt particles or salt pellets on the link 108 for melting snow. For example, the set of vehicle features relating to the dispensing vehicle 110 (referred to as salt dispensing vehicle 110, hereinafter) may include a speed of the salt dispensing vehicle 110, rate of dispensing of salt by the salt dispensing vehicle 110, a size of dispensing opening on the salt dispensing vehicle 110 for dispensing salt, any other opening on the salt dispensing vehicle 110, an amount of salt dispensed at a particular area or location, time of dispensing or movement of the salt dispensing vehicle 110, and the like.

The system 102 may then determine a set of risk-related features, for the salt dispensing vehicle 110. For example, the set of risk-related features may include, but are not limited to, rate of melting of snow due to the dispensed salt, change in a road condition parameter due to salt (such as, a level of slipperiness, any water logging due to melting, etc.), change in driving condition parameter due to the dispensed salt (such as, slipping of tires, loss of control, etc.) and an impact on a vehicle (such as, impact on outer body and/or windshield) due to the dispensed salt. Based on the set of risk-related features and the map data associated with the link 108, the system 102 may determine a risk value for the link 108. In an example, the system 102 may determine the risk value to be high for travelling on the link 108 at a time immediately after dispensing of the salt on the link 108, at a time before snowfall when salt has been dispensed on the link, or at a time after snowfall when map data indicates curved area on the link 108 has high speed limits. It may be noted that risky road condition may arise due to slippery nature of a surface of the link 108 after snowfall subsequent to the salt dispensing. In an example, the road condition may be risky or unsafe due to slippery roads having curved area and high speed limits on which other vehicles may also travel at higher speed limits. In another example, the road condition may be risky or unsafe due to roads, such as the link 108, having salt particles, such as before snowfall, wherein the salt particles may get accelerated by other vehicles travelling on the link 108 and may get in contact with body of vehicles to cause physical damage to the body of the vehicle. To this end, the risk value for the risky road conditions may be greater than risk value for non-risky road conditions. Once the risk value for the link 108 is determined, the risk value may be used to update the map database 104b. In an example, the map database 104b may be updated to store the risk value in conjunction with information associated with the link 108. Subsequently, the updated map database 104b having the risk value may be used to generate navigation instruction so as to avoid areas where salt particles are dispensed, such as the link 108.

For example, a driver of a vehicle that may be planning to travel on the link 108 or that may be currently travelling on the link 108 may be provided with a risk warning message. For example, in case of risk value being higher than a predefined threshold and indicating high risk or risky road condition on the link 108, the system 102 may provide an alternative link recommendation for avoiding travelling on the link 108 or may provide a risk warning message for travelling on the link 108. The alternative link recommendation may include an alternative link having a risk value lower than the risk value of the link 108, thereby indicating lower risk on the alternative link. For example, the risk value may also indicate a level of impact of the dispensed particles or salt particles on road condition and vehicles travelling on the link 108. In an example, the predefined threshold may indicate a tolerance level that must be exceeded by the dispensed particles or salt particles in order to affect vehicles. For example, the risk value may be higher than the predefined threshold right after dispensing of salt particles before snowstorm. Moreover, the risk value may be lower than the predefined threshold after a certain time period after the snowstorm. For example, the predefined threshold may be set dynamically based on road condition, environmental condition and impact associated with normal road condition without any dispensed particles. Subsequently, when the risk value of the link 108 is higher than the predefined threshold, the link may be considered as high risk.

To this end, based on the risk value, navigation instructions may be generated and/or updated. The navigation instructions may be provided to a vehicle for routing along the link 108. A manner in which the risk value is generated for the link 108 is further described in detail in conjunction with the following figures.

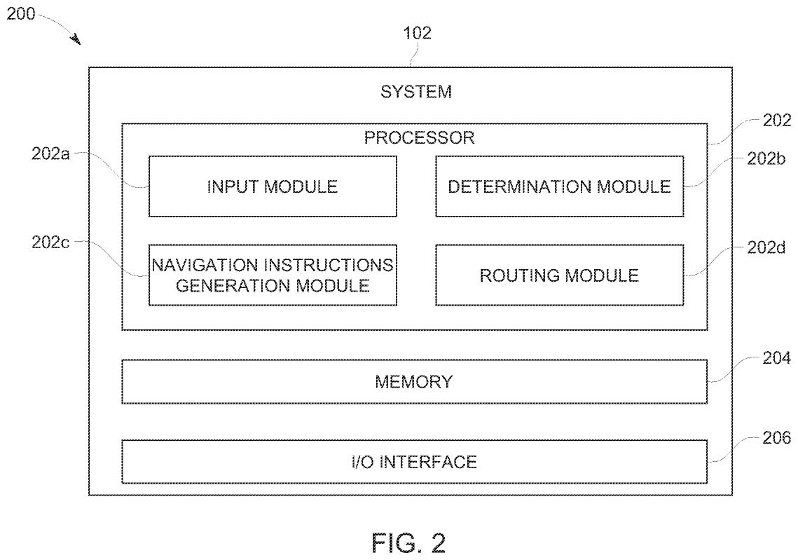

FIG. 2 illustrates a block diagram 200 of the system 102, exemplarily illustrated in FIG. 1 that may be used for providing risky road condition warning, in accordance with an example embodiment. FIG. 2 is explained in conjunction with FIG. 1.

The system 102 may include at least one processor 202, a memory 204, and an I/O interface 206. The at least one processor 202 may comprise modules, depicted as an input module 202a, a determination module 202b, a navigation instructions generation module 202c and a routing module 202d.

In accordance with an embodiment, the system 102 may store data that may be generated by the modules while performing corresponding operation or may be retrieved from a database associated with the system 102. In an example, the data may include map data, probe data, sensor data, set of vehicle features associated with dispensing vehicles, and navigation or routing instructions.

In accordance with an embodiment, the input module 202a may obtain a set of vehicle features associated with the dispensing vehicle 110. For example, the input module 202a may access the map database 104b and/or other databases associated with the system 102, the dispensing vehicle 110 and the vehicles 106, to obtain the set of vehicle features. In an example, the map database 104b and/or the other databases may receive such set of vehicle features associated with the dispensing vehicle 110 based on tracking of the dispensing vehicle 110, data from other vehicles travelling on a route same as the dispensing vehicle 110, and/or a third-party server associated with an organization associated with the dispensing vehicle 110. The set of vehicle features associated with the dispensing vehicle 110 may include, but are not limited to, a travel route of the dispensing vehicle 110, dimensions associated with a dispensing opening of the dispensing vehicle 110, a total load carried by the dispensing vehicle 110, a type of material or goods carried by the dispensing vehicle 110, an amount of particles dispensed from the dispensing opening of the dispensing vehicle 110 in a particular area, a rate of dispensing of particles through the dispensing opening, and time of travel of the dispensing vehicle 110. In an example, for a salt dispensing vehicle 110, the set of vehicle features may include components of a mixture of salt to be dispensed by the dispensing vehicle 110.

In addition, the input module 202a may access the map database 104b and/or other databases associated with the system 102, the dispensing vehicle 110 and the vehicles 106, to obtain map data. The map data may be historical or real-time data indicating structure, shape, size, geometry etc. of the link 108. In an example, the map data may include other information, such as probe data, link data, intersection data, traffic data, etc. For example, the map data may include, but is not limited to, data relating to link geometry (such as, shape, size, structure, curved areas, etc.) of the link 108, speed limit for the link 108, intersections information (such as, information associated with one or more intersection or node) associated with the link 108, and other link conditions (such as, traffic light information, traffic information, lane data, and so forth).

The determination module 202b may be configured to determine a set of risk-related features, based on the set of vehicle features associated with the dispensing vehicle 110. The set of risk-related features may include attributes that indicate impact of particles dispensed form the dispensing vehicle 110 on road conditions or when a vehicle encounters the particles. For example, the set of risk-related features may be determined by processing the set of vehicle features to infer the effect of the particles dispensed from the dispensing vehicle 110. In an example, the risk-related features may include change in a road condition parameter due to particles dispensed by the dispensing vehicle 110. In particular, the road condition parameter may indicate an effect of the dispensed particles on a surface of the link 108. The vehicle may be a vehicle travelling along the link after the dispensing vehicle 110 dispenses the particles. For example, if salt particles are dispensed by the dispensing vehicle 110, the road condition parameter may indicate a change on the surface of the link 108, such as increased slipperiness at the surface of the link 108 due to salt pellets. To this end, the determination module 202b determines the change is road condition parameter, for example, change in slipperiness of the surface of the link 108, to determine effect of the dispensed particles on road condition.

In another example, the set of risk-related features may include change in a driving condition parameter due to the particles dispensed by the dispensing vehicle 110. The driving condition parameter may indicate a change in state of, for example, light (for example, reduced visibility due to the dispensed particles), weather (for example, change in driving conditions due to effect of weather on the dispensed particles), traffic (for example, obstruction on road or risky road condition causing traffic jams due to dispensed particles, and so forth), and vehicle (for example, loss of control, slipping of tire and so forth). In an example, the driving condition parameter may affect a driver's ability to control the vehicle and may affect safety of the vehicle and other entities (such as, vehicle or people) in proximity of the vehicle. For example, when salt is dispensed by the dispensing vehicle 110, the change in the driving condition parameter may indicate change in tire conditions of a vehicle due to slippery roads because of salt dispensed on roads.

In another example, the set of risk-related features may include an impact parameter associated with impact of the dispensed particles by the dispensing vehicle 110 on a vehicle on the link 108. The impact parameter may indicate an impact on the outer body of the vehicle due to encounter of particles dispensed by the dispensing vehicle 110 with the vehicle. For example, the salt particles dispensed by the dispensing vehicle 110 may get accelerated due to movement of vehicles 106 on the link 108. To this end, the accelerated salt particles may impact outer body of the vehicles (such as vehicles from 106) on the link 108. For example, the salt particles may cause dent or scratches to the outer body, such as chassis and windshield, of the vehicles that may come in contact with such salt particles. In an example, the impact parameter may be determined based on, for example, constituents of salt dispensed by the dispensing vehicle 110, amount of salt particles dispensed by the dispensing vehicle 110, speed of the dispensing vehicle 110, speed limit of the link 108, car type, etc. of a vehicle. The impact parameter may indicate an extent of physical damage (dent or scratches) that may be caused due to the encounter of the salt particles with the vehicle.

Thereafter, the determination module 202b may be configured to determine risk value associated with the link 108. For example, the risk value may be a score determined based on the set of risk-related features and the map data. In an example, if the change in the road condition parameter and driving condition parameter indicates slippery road condition due to salt particles dispensed by the dispensing vehicle and the map data indicates curved area on the link 108 or high speed limit on the link 108, the risk value calculated by the determination module 202b may be high to indicate risk road conditions. In another example, if salt is dispensed from the dispensing vehicle 110 on clear link 108 and no snowfall is recorded yet, the change in impact parameter indicates encounter of salt particles with vehicles that may damage the vehicle. In such a case, if the map data indicates curved area on the link 108 or high speed limit on the link 108, the risk value calculated by the determination module 202b may be high to indicate risky road condition. To this end, the high risk value may be a numerical value higher than a predefined threshold.

In an example, the determination module 202b may determine updated risk value for the link 108 dynamically after predetermined intervals of time. For example, after a predetermined interval, the determination module 202b may determine a set of risk-related features again to check for improvement or degradation in, for example, driving condition parameter, road condition parameter, and impact parameter. Subsequently, the determination module 202b determines updated risk value after the predetermined intervals of time.

In accordance with an example, the determination module 202b may compare risk value of the link 108 with a predefined threshold to determine a level of risk while travelling on the link 108 due to dispensed particles. In an example, the predefined threshold may be predetermined by the determination module 202b or provided by a user associated with the system 102. In another example, the predefined threshold for the risk value may be defined by a user, such as a driver, associated with a vehicle. For example, if the driver wants to avoid any risky situation that may affect their vehicle, the driver may set the predefined threshold to a lower value.

Based on the risk value of the link 108, the navigation instructions generation module 202c may generate or update navigation instructions. The updated navigation instructions may include, for example, an alternative link recommendation for avoiding the link 108 when the risk value is higher than the predefined threshold. In another example, the updated navigation instructions may include a risk warning message for the link 108 when the risk value is higher than the predefined threshold. In an embodiment, generating updated navigation instructions may include updating road condition information at the link 108, updating color codes of the link 108, updating routing message based on the risk value, and so forth.

In accordance with an embodiment, the risk value and the predefined threshold may be fed to the navigation instructions generation module 202c. Based on the input, the navigation instructions generation module 202c may update navigation instructions of a vehicle that may be travelling along a route including the link 108 based on the risk value. A driver of the vehicle travelling along the route including the link 108 may choose to cross or avoid the link 108 in due course of travel.

In accordance with an embodiment, the processor 202 may also store the risk value for the link 108 in the map database 104b. The risk value may be time stamped for storing. Based on the updated navigation instructions, the routing module 202d may provide the updated navigation instructions as routing information to a vehicle or a user equipment. In an example, the routing module 202d may be configured to generate user readable or user-understandable routing instructions, such as routing messages, notifications, risk warning message, etc., based on the updated navigation instructions and the risk value. The routing module 202d may send or push the routing messages to user equipment to enable routing of the vehicle. In an example, the routing module 202d may generate user-readable incident warning message. For example, the risk warning message may include “avoid lane “X” as salt truck dispensed 300 pounds of salt on this lane over a 5 mile range”.

The above presented modules and components of the system 102 can be implemented in hardware, firmware, software, or a combination thereof. Though depicted as a separate entity in FIG. 1, it is contemplated that the system 102 may be implemented as a module of any of the components of the mapping platform 104. In another embodiment, one or more of the modules 202a-202d may be implemented as a cloud based service, local service, native application, or combination thereof.

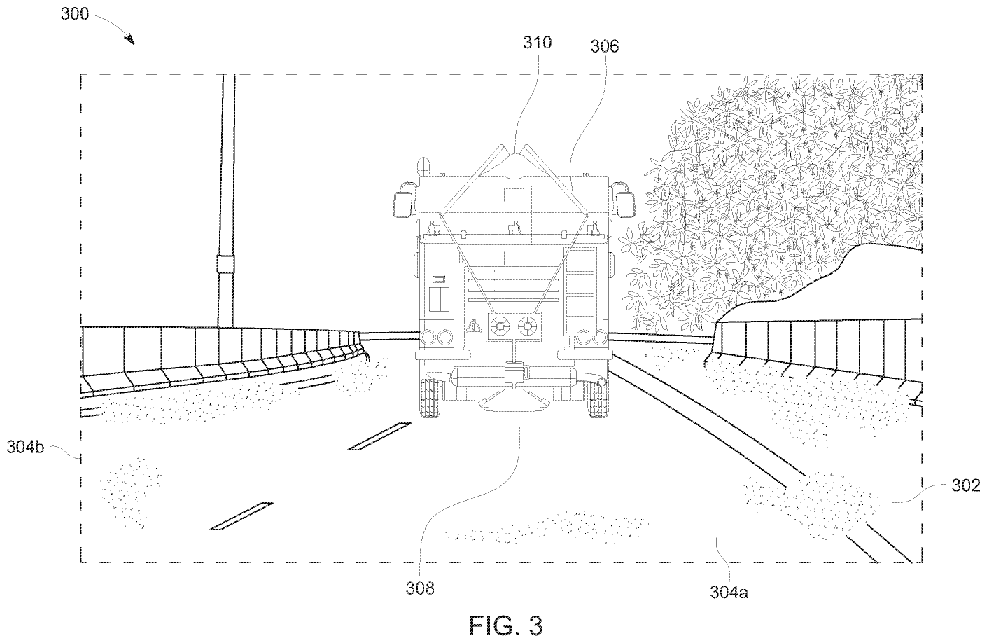

FIG. 3 shows an exemplary environment 300 where a risk value corresponding to a link 302 is calculated, in accordance with an example embodiment.

With reference to FIG. 3, the environment 300 includes the link 302 having two lanes 304a and 304b. The lanes 304a and 304b may be road segments for uplink traffic. The lanes 304a and 304b are separated based on lane markings. As shown in FIG. 3, a salt dispensing vehicle 306 is travelling on the uplink lane 304a of the link 302.

The salt dispensing vehicle 306 has openings. In particular, the salt dispensing vehicle 306 (referred to as salt truck 306, hereinafter) has a dispensing opening 308 at a lower side of the salt truck 306 for dispensing salt from the salt truck 306 on the lane 304a. The salt truck 306 also has a top opening 310 at a top side of the dispensing vehicle 306. The top opening may be used to fill or empty a cargo bed of the salt truck 306. During motion of the salt truck 306, the dispensing opening 308 may dispense certain amount of salt from the cargo bed on a surface of the lane 304a of the link 302 over a given distance, for example, 1 meter, 1 kilometer, 5 kilometers, 15 kilometers, etc.

Although the present example is described as dispensing vehicle being operable to dispense salt. However, this example should not be construed as a limitation. In other examples of the present disclosure, the dispensing vehicle may not be operable to dispense other type of particles readily through the dispensing opening 308. Further, the dispensing vehicle may dispense any type of particles or objects including, but not limited to, sand, gravel, coal, asphalt, agricultural produce, scrap, rock, construction material, and wood.

Returning to present example, the salt truck 306 may be used to pre-treat the link 302 prior to a weather event that could potentially leave ice or snow on the link 302, with intent of preventing ice from accumulating and/or preventing slippery road conditions. In other example, the salt truck 306 may be used to treat the link 302 before the weather event or during the weather event too. To this end, the salt particles may make the surface of the lane 304a slippery thereby creating a risky road condition. In an example, the risky road condition may be evaluated by the system 102 to determine a risk value associated with the link 302, specifically, the lane 304a. For example, the risk value may be determined based on a set of vehicle features associated with the salt truck 306, a set of risk-related features due to the dispensing of the salt particles, and map data associated with the link 302.

In an example, the risk value for the lane 304a may be determined based on features comprising a set of vehicle features, a set of risk-related features and map data. Examples of such features may include, but are not limited to, a time at which the salt truck 306 dispense salt particles on the lane 304a, a rate of dispensing the salt through the dispensing opening 308, a travel route of the salt truck 306, a time at which the weather event occurs, environmental impact of the weather event on the dispensed particles amount of time it takes to melt the ice or snow after the weather event, speed limit of the link 302, speed of the dispensing vehicle 110, and actual speed of vehicles travelling on the link 302. In accordance with the present example, the salt truck 306 may be dispensing only sodium salt for melting ice; however, this should not be construed as a limitation. In other examples, the truck may have a mixture of salt and another compound (such as, salt and sand, sodium, and other types of salt, and so forth), or the truck may dispense some other compound (such as beet) for melting ice or snow.

In operation, the system 102 obtains a set of vehicle features associated with the salt truck 306. The set of vehicle features may include, for example, speed of the salt truck 306, amount of salt carried by the salt truck 306, dimensions of the salt truck 306, dimensions of the dispensing opening 308, a total distance covered by the salt truck 306, travel route of the salt truck 306, time of travel of the salt truck 306, rate of dispensing of salt through the dispensing opening 308, and the like. The system 102 may also obtain environment data associated with the link 302. The environment data includes environmental effect on dispensed particles. For example, environmental effect includes a rate of melting of the salt dispensed from the salt truck 306. In an example, the set of vehicle features may be obtained from probe vehicles travelling on the link 302 at a time when the salt truck 306 is dispensing salt, before the dispensing of salt and/or after the dispensing of salt. In another example, the set of vehicle features may be obtained from a third-party server associated with the salt truck 306. For example, the third-party server may be associated with an organization that deploys the salt truck 306 for dispensing salt on the link 302.

Based on the set of vehicle features associated with the salt truck 306 and environmental effects on the dispensed or released salt, the system 102 may determine a set of risk-related features. The system 102 may determine the set of risk-related features by fusing the set of vehicle features with effect of the set of vehicle features on driving conditions, road condition and conditions of the link. In an example, the risk-related features may be determined based on time of dispensing of salt from the salt truck 306. It may be noted that the link 302 treated with salt 2 hours before the weather event, such that snowfall may be unsuitable for vehicles due to high salt concentration on roads and less amount of ice or snow for dissolving the salt after the treatment. In case of high speed limit of the link, the salt particles may be accelerated to impact on outer body of the vehicle. The encounter between the salt particles and the vehicle may cause dent and scratches, and also increased corrosive effect thereby making the link 302 more unsuitable for travel. Further, the link 302 treated with salt 1 hour after the weather event may be more suitable for travelling as there may be some amount of ice or snow already on the link 302, thereby reducing amount of salt that may impact the vehicles and have corrosive effect.

In another example, the risk-related features are determined based on the amount of time it takes the salt to melt, i.e., environmental effect on salt. For example, an organization, such as a local authority or a municipality, may procure the salt from different suppliers or distributors. Subsequently, different types of salt may be dispensed by the salt truck 306, and the different types of salt may have different composition. As a result, environmental effect on the different salt compositions may be different that affects or could affect disintegration or decomposition of the salt. In an example, the disintegration of the salt may further depend on, for example, ingredients or composition, type of ground surface or asphalt on the link 302, weather and wind, traffic volume, speed limits, tires, and the area where the salt lands or settles.

In another example, the risk-related features are determined based on a speed limit of the link 302 and actual speed of vehicles travelling on the link 302. In an example, particles, such as salt pellets, in the air may affect road conditions adversely. Specifically, dispensed particles in air on a link where speed limit is high may affect the road conditions adversely and create risky road condition. Further, a probability of occurrence of the risk increases based on speed limit of the road and the actual speed of the vehicles traveling through these areas. For example, certain vehicles may travel faster in certain lanes, such as left lane, or on certain roads, such as highways, etc. For example, the salt truck 306 may be followed by a snow plough for plowing the snow or ice after a pre-defined time interval from a time of dispensing the salt and/or the weather event. Subsequently, the snow plough may also affect road conditions as snow or ice ploughed by the snow plough may cover windshield of a vehicle and obstruct driver's ability to see and can cause damage to vehicles and injury or death to operators. Therefore, the risk-related features may be determined based on the map data, such as speed limit and geometry of the link 302.

Based on the time of salt dispensing, the amount of salt dispensed, amount of time taken for the salt to melt or disintegrate, speed and geometry, the system 102 may determine change in driving condition parameter, change in road condition parameter and/or impact parameter when the salt encounters vehicles. For example, the change in driving condition parameter, change in road condition parameter and/or impact score may indicate a change in condition of roads rendering it suitable or unsuitable for use.

Thereafter, a risk value for the link 302 may be determined, based on the set of risk-related features, the map data, and the environment data. For example, the set of risk-related features may be assessed based on the map data, for example, speed limit, intersection, curvature, etc., of the link 302. In an example, risk value may be an assessment score indicating a level of risk or unsuitability of travelling on the link 302 owing to the impact of the dispensed salt on the road conditions, driving conditions, and vehicles.

In an example, the map data may also indicate link condition of the link 302. For example, the link condition may indicate potholes, water build-up, open sewage, debris around potholes, etc. Such link condition may also affect driving condition on the link 302. Subsequently, the risk value for the link 302 may be calculated based on the link condition. For example, a lane having a pothole or water build-up may be identified and subsequently provided a high risk value In this manner, lanes or links having bad condition may be avoided.

The determined risk value may be used to update the map database 104b. In an example, the risk value may be utilized by a navigation system for routing. For example, the navigation system may obtain the risk value and create a route for navigation of a vehicle based on the risk value for the link 302. The navigation system may then provide a user associated with the vehicle or the vehicle with a generated route. The generated route may have real-time orientation and reorientation navigation directions voice or text, based on the risk value. In an example, the navigation instructions may include voice or text incident warning message based on high risk value. In one example, the voice or text risk warning message may be “m to center lane from the right lane because a salt truck released 300 pounds of salt in the right lane over a 5-mile range”.

Although the particles dispensed in the present example is salt, such nature of particles should not be construed as a limitation. Therefore, such types of particles may also cause change in road condition parameter, change in driving condition parameter and impact parameter of a vehicle travelling on same link. It is imperative to analyze a level of risk due to such dispensed objects and particles to ensure safe and risk free driving condition. This may prevent physical damage to vehicles, avert any driving incident, as well as ensure cost savings in insurance.

In an example, a confidence score of the system 102 or recommendation provided by the system 102, such as recommendation provided as part of the updated navigation instructions, may be determined. In an example, the confidence score may be determined based on a frequency and usage of the recommendation to the vehicle to which the updated navigation instructions were provided. In another example, when a vehicle does not follow the recommendation and travels, for example, rear to the dispensing vehicle, the confidence score may be determined based on vehicle attributes of the vehicle. The vehicle attributes may include, for example, frequency of windshield wiper usage, frequency of the windshield wiper fluid being used, weight of the debris being cleared by the windshield wipers, impact or crack on the windshield, impact of tires, and break-down of the vehicle. For example, when the debris lands on the windshield and/or the windshield wipers, the windshield wipers may measure an amount of power or force used to clear the debris from the windshield. In this regard, when more power or force used to remove the debris, the confidence score is determined to be high. Further, in case of break-down of vehicle, causing halt of vehicle, the confidence score is determined to be high. Similarly, in case of an impact detected on the windscreen, the confidence score is determined to be high.

It may be noted that risk warning message is not provided merely on the basis of travel of the dispensing vehicle, speed limit, and presence of traffic signs and lights, and these factors for determination of risk value and generating risk warning messages are used merely as examples. The actual determination of the risk value, and generation of navigation instruction and incident warning messages may be based on a number of factors, such as type of particles, amount of dispensed particles, wind speed, speed limit, weather conditions, temperature, link and intersection information, links adjoining the link 302 for which risk value is to be determined, link conditions, amount or weight carried by the dispensing vehicle, type of dispensing vehicle, size of dispensing vehicle, curvatures on the link 302, etc. Moreover, route generation based on the risk value may be performed in real-time or in future. Subsequently, updated navigation instructions generated based on the risk value may be provided to a vehicle travelling on the link 302 being maneuvered by the dispensing vehicle in real-time, as well as navigation instructions generated based on the risk value may be provided to another vehicle in future that may travel on the link 302 previously maneuvered by the dispensing vehicle. On receiving the updated navigation instructions, the vehicle may be able to avoid any physical damage or difficulty in driving owing to particles dispensed from the dispensing vehicle 306.

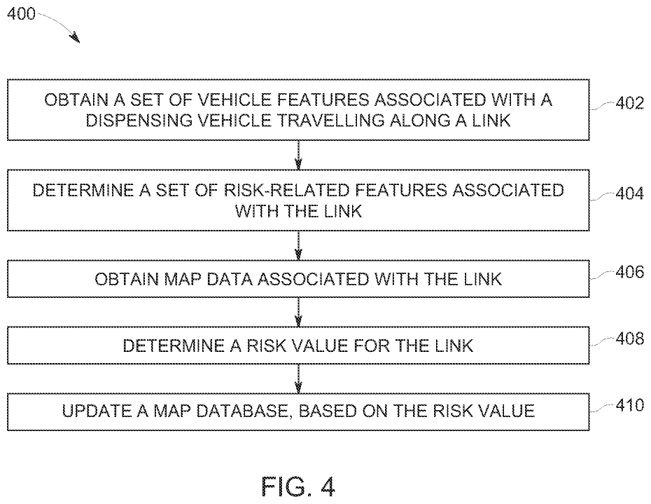

FIG. 4 illustrates a flowchart for implementation of an exemplary method 400 for providing risk warning, in accordance with an embodiment. In various embodiments, the mapping platform 104 or the system 102 may perform one or more portions of the method 400 and may be implemented in, for instance, a chip set including a processor and a memory. As such, the mapping platform 104 or the system 102 may provide means for accomplishing various parts of the method 400, as well as means for accomplishing embodiments of other processes described herein in conjunction with other components of the system 102. Although the method 400 is illustrated and described as a sequence of steps, its contemplated that various embodiments of the method 400 may be performed in any order or combination and need not include all of the illustrated steps.

At 402, a set of vehicle features associated with the dispensing vehicle 110 travelling along the link 108 is obtained. In an example, the set of vehicle features associated with the dispensing vehicle 110 is determined based on tracking of the dispensing vehicle 110. In this regard, the tracking of the dispensing vehicle 110 may be performed based on at least one of: the vehicles 106 travelling along a travel route of the dispensing vehicle 110, or metadata provided by a third-party server associated with the dispensing vehicle 110. Subsequently, the set of vehicle features may be obtained as sensor data from the vehicles 106 and/or the third-party server associated with the dispensing vehicle 110. For example, the vehicles 106 may be configured to send the set of vehicle features as part of the sensor data periodically, or at predefined time intervals, such as 30 second, 1 minute, 2 minutes, 5 minutes, etc. In an example, the vehicles 106 may be triggered to send the sensor data on identifying the dispensing vehicle 110 or anomalous driving conditions, such as reduced visibility, loss of tire control, break-down, physical damage, etc.

In an example, the set of vehicle features associated with the dispensing vehicle 110 includes at least one of: the travel route of the dispensing vehicle 110, an amount of particles dispensed from a dispensing opening of the dispensing vehicle 110, rate of dispensing of particles, or time of travel of the dispensing vehicle 110.

At 404, a set of risk-related features associated with the link 108 is determined, based at least on the set of vehicle features. In an example, the risk-related features may indicate impact of particles dispensed from the dispensing vehicle 110 on the environment, vehicles 106 and/or driving conditions. For example, the set of risk-related features associated with the link 108 includes at least one of: change in a road condition parameter due to particles dispensed by the dispensing vehicle 110, change in driving condition parameter due to the particles dispensed by the dispensing vehicle 110, or an impact parameter of physical impact or damage of the particles dispensed by the dispensing vehicle on a following vehicle on the link 108.

At 406, map data associated with the link 108 is obtained. In an example, the map data includes at least one of: link geometry, speed limit, intersections information, or link conditions associated with the link 108. In an example, the map data may be obtained from the map database 104b, wherein such map data is gathered based on real-time and historical sensor data, and real-time and historical probe data.

In certain cases, environment data may also be obtained from the map database 104b. The environment data may include environmental effect on particles dispensed from the dispensing vehicle 110. The environmental effect may be due to, for example, wind speed, temperature, weather conditions, disaster, etc.

At 408, a risk value for the link 108 is determined based on the set of incident-related features and the map data. The risk value may indicate a level of risk associated with travelling on the link 108. Such risk may arise due to the particles dispensed from the dispensing vehicle 110. In an example, the risk value may be a score such as a numerical value, a grade such as an alphabetic grade, and so forth. For example, the risk value may be determined based on the map data, the set of risk-related features and the environment data, i.e., effect of such features on road conditions on the link 108. For example, if the risk value is higher than a predefined threshold, the link 108 may be considered to have risky road condition. Alternatively, if the risk value is lower than a predefined threshold, the link 108 may be considered as suitable, less-risky, or not risky for travel. To this end, the predefined threshold may be predetermined by the system 102 based on a risk tolerance of a vehicle to which the system 102 may provide the risk value, may be determined in real-time by the system 102 based on the risk tolerance of the vehicle, or may be predefined or defined in real-time by a driver of the vehicle based on a desired risk tolerance of the vehicle.

In accordance with an example embodiment, the dispensing vehicle 110 is a vehicle for dispensing salt, a mixture of salt and sand, road salt, etc., on the link 108. During the dispensing of salt on the link 108, the link 108 may have snow accumulate, on to which the salt may be dispensed. In certain cases, the salt may be dispensed on clear link 108 prior to weather event leading to accumulation of snow, i.e., prior to a predicted time for snowfall. When salt is dispensed on clear link 108, the vehicles travelling on the link 108 may accelerate the salt particles and may cause encounter of the vehicle body or other vehicle's body with salt particles. Such encounter may cause physical damage to the body of the vehicle or the other vehicle. Subsequently, during the dispensing of salt particles, the link 108 may have to be avoided. In this regard, the system 102 obtains a set of vehicle features associated with the salt dispensing vehicle 110 from, for example, a third-party server associated with a local organization that operates the salt dispensing vehicle 110. The set of vehicle features may include, for example, route, speed, rate of dispensing, etc. For example, the route of the salt dispensing vehicle 110 may include the link 108. In an example, the system 102 may also obtain environment data, such as wind speed, temperature, etc. associated with the route of the salt dispensing vehicle 110. Based on the set of vehicle features and the environment data, the system 102 may determine a set of risk-related features associated with the link 108. The set of risk-related features may include, for example, change in road condition parameter on the link 108 due to salt, change in driving condition due to salt, an impact parameter for an encounter between the salt particles and a vehicle, and change in road conditions (for example, slipperiness of the link 108, etc.). The system 102 may then obtain map data corresponding to the link 108. The map data may include, for example, road curvature, intersection information, link information, speed limit, etc. Based on the map data, the set of risk-related features, and the environment data, the system 102 may determine the risk value for the link 108. The system may then compare the determined risk value with a predefined threshold of risk. In an example, the predefined threshold may be predefined for a vehicle by a user or driver associated with the vehicle. For example, based on the comparison, the system 102 may determine if the link 108 is risky for travel by the vehicle. For example, if the risk value is higher than the predefined threshold, the system 102 may determine the link 108 to be risky road condition or high risk. Subsequently, navigation instructions for the vehicle travelling on the link may be generated or updated to indicate high risk driving condition.

At 410, the risk value is stored in the map database 104b. In an example, the system 102 may update map database 104b based on the risk value. The system 102 may update navigation instructions for travelling on the link 108 based on the risk value. In an example, a navigation system may use the risk value for generating and/or updating navigation instructions in real-time or in future. In an example, the updated navigation instructions may include an alternative link recommendation to avoid the link 108 or a risk warning message for travelling on the link 108, when the risk value is more than the predefined threshold, i.e. high risk value.

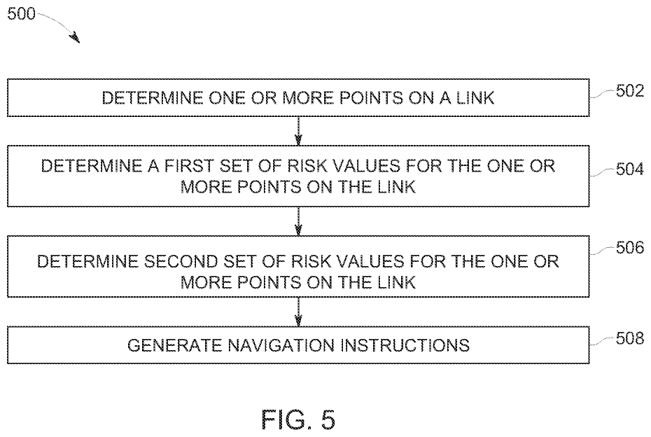

In certain case, the risk value for the link 108 may be generated periodically. The present example is explained in detail in conjunction with the FIG. 5.

FIG. 5 illustrates a flowchart for example implementation of an exemplary method 500 for determining risk value, in accordance with an embodiment. For example, the method 500 may be performed at step 408 in the FIG. 4. In various embodiments, the mapping platform 104 or the system 102 may perform one or more portions of the method 500 and may be implemented in, for instance, a chip set including a processor and a memory. As such, the mapping platform 104 or the system 102 may provide means for accomplishing various parts of the method 500, as well as means for accomplishing embodiments of other processes described herein in conjunction with other components of the system 102. Although the method 500 is illustrated and described as a sequence of steps, its contemplated that various embodiments of the method 500 may be performed in any order or combination and need not include all of the illustrated steps.

At 502, one or more points on the link 108 are determined. In an example, the one or more points may correspond to a geographical point or coordinate on the link 108. In an example, the one or more points may correspond to, but are not limited to, entry point of the link 108, exit point of the link 108, start point of a curvature on the link 108, end point of a curvature on the link 108, affected area (such as, area having pothole, water build-up, large amount of snow deposit, etc.), link condition, and area having large amount of dispensed particles on the link 108.

At 504, a first set of risk value for the one or more points on the link 108 is determined. In an example, the system 102 determines the first set of risk value for the one or more point on the link 108 at a first time period. For example, the first time period may correspond to a time period during which the dispensing vehicle 110 is travelling and dispensing particles along the link 108. In accordance with an example, the system 102 may determine the first set of risk value for each of the one or more points on the link 108 at predetermined intervals of time, based on the set of risk-related features and the map data associated with the link 108.

At 506, a second set of risk value for the one or more points on the link 108 is determined. In an example, the system 102 determines the second set of risk value for the one or more point on the link 108 at a second time period. For example, the second time period may correspond to a time period after the travelling of the dispensing vehicle 110 on the link 108, i.e., the dispensing vehicle 110 has already travelled and dispensed particles along the link 108. For example, the system 102 may determine risk value for such one or more points on the link 108 at predetermined intervals of time to identify risks at different time instances before, during and/or after travelling or maneuvering of the dispensing vehicle 110 on the link 108. It may be noted that such risk value may be dynamic owing to changing nature of risk value at different instances of time. To this end, the determination of the set of risk values for the one or more points on the link 108 during and after the dispensing of particles should not be construed as a limitation. In other embodiments, a greater number of sets of risk values may be determined at different time before, during and after maneuvering of the dispensing vehicle 110.

At 508, navigation instructions are generated based on the first set of risk values and the second set of risk values. In an example, the system 102 may generate or update navigation instructions based on the set of risk values of the one or more points on the link 108. In particular, the system 102 may utilize a most recent or current set of risk values to update previously generated navigation instructions or generate new navigation instructions based on the current risk value.

Accordingly, blocks of the flowcharts 400 and 500 support combinations of means for performing the specified functions and combinations of operations for performing the specified functions for performing the specified functions. It will also be understood that one or more blocks of the flowchart 400 and the flowchart 500, and combinations of blocks in the flowchart 400, and the flowchart 500, can be implemented by special purpose hardware-based computer systems which perform the specified functions, or combinations of special purpose hardware and computer instructions.

Alternatively, the system may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the method 400 and the method 500 disclosed herein, the end result generated by the system 102 is a tangible generation of navigation instructions for a link. The generation of navigation instructions is necessary to avoid risky or unsuitable road conditions and averting any risk.

Returning to FIG. 1, additional, fewer, or different components may be provided. For example, a proxy server, a name server, a map server, a cache server or cache network, a router, a switch or intelligent switch, a geographic database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, the system 102 may be communicatively coupled to the components shown in FIG. 1 to carry out the desired operations and wherever required modifications may be possible within the scope of the present disclosure.

In some example embodiments, system 102 may be coupled to the vehicles 106, via user equipment. In an embodiment, the system 102 may be coupled to one or more user equipment, for example, as a part of an in-vehicle navigation system, a navigation app in a mobile device and the like. The user equipment may be any user accessible device such as a mobile phone, a smartphone, a portable computer, and the like that are portable in themselves or as a part of another portable/mobile object such as the vehicles 106. The user equipment may comprise one or more sensors, a processor, a memory, and a communication interface. The processor, the sensors, the memory, and the communication interface may be communicatively coupled to each other. In some example embodiments, the user equipment is associated, coupled, or otherwise integrated with the vehicles 106 as, for example, an advanced driver assistance system (ADAS), a personal navigation device (PND), a portable navigation device, an infotainment system and/or other device that may be configured to provide route guidance and navigation related functions to users. For example, the user equipment may be configured to execute and run mobile applications such as a messaging application, a browser application, a navigation application, and the like.

In some example embodiments, the vehicles 106 may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, an image sensor such as camera, a display enabled user interface such as a touch screen display, and other components as may be required for specific functionalities of the vehicles 106.

In one embodiment, the vehicles 106 may be directly coupled to the system 102 via the network 112. In another embodiment, the vehicles 106 may be coupled to the system 102 via an OEM (Original Equipment Manufacturer) cloud and the network 112. For example, the vehicles 106 may be consumer vehicles and may be a beneficiary of the services provided by the system 102. In some example embodiments, the vehicles 106 may serve the dual purpose of data gatherers and beneficiary devices. In an example, the vehicles 106 may be configured to detect road conditions and vehicle conditions on links and/or road segments by using sensors that are on-board the vehicles 106. In another example, the user equipment within the vehicles 106 may be configured to gather sensor data using sensors on-board the vehicles 106 and sensors of the user equipment. The user equipment then sends the detected data to the system 102, which processes the detected data to provide incident warning and generate and update navigation instructions.

In an example embodiment, the system 102 may be onboard the vehicles 106, such as the system 102 may be a navigation system installed in the vehicles 106 for processing data, providing incident warning, and generating and/or updating navigation instructions. In an example, the vehicles 106 may be an autonomous vehicle, a semiautonomous vehicle, or a manually operated vehicle. In another example embodiment, the system 102 may be the processing server 104a of the mapping platform 104, and therefore may be co-located with or within the mapping platform 104. For example, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, such as from the user equipment, the vehicles 106, or a third-party database, before using the data for further processing, such as before sending the data to map database 104b. In an example, anonymization of the data may be done by the mapping platform 104.

The system 102 may be communicatively coupled to the vehicles 106, the dispensing vehicle 110, and the mapping platform 104, via the network 112. In an embodiment, the system 102 may be communicatively coupled to other components, for example, user equipment, and so forth, not shown on FIG. 1 via the network 112. The network 112 may be wired, wireless, or any combination of wired and wireless communication networks, such as cellular, Wi-Fi, internet, local area networks, or the like. In some embodiments, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the network 112. The components described in the network environment 100 may be further broken down into more than one component and/or combined together in any suitable arrangement. Further, one or more components may be rearranged, changed, added, and/or removed.

The system 102 may comprise suitable logic, circuitry, and interfaces that may be configured to process data for providing incident warning and generating and/or updating navigation instructions. The system 102 may be configured to assess risk caused due to particles dispensed form the dispensing vehicle 110. In an example, the dispensing vehicle 110 may be an automotive vehicle propelled by an electric or and internal combustion (IC) engine.

Returning to FIG. 2, the processor 202 may retrieve computer executable instructions that may be stored in the memory 204 for execution of the computer executable instructions. The memory 204 may store the set of vehicle features, the map data, and/or risk value associated with the link 108 and the dispensing vehicle 110. In accordance with an embodiment, the processor 202 may be configured to retrieve input (such as, real-time sensor data, historical probe data, real-time probe data, map data indicating map attributes associated with the link 110, the set of vehicle features associated with the dispensing vehicle 110, and historical risk value) from background batch data services, streaming data services or third party service providers, and renders output, such as, the risk value for the link 108 for use by the end user through the I/O interface 206.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the I/O interface 206 of the system 102. The I/O interface 206 may provide an interface for accessing various features and data stored in the system 102.

The processor 202 of the system 102 may be configured to determine risk value for travelling on the link 108, based on the set of vehicle features and the map data. Further, based on the risk value of the link 108, the processor 202 may generate or update navigation instructions. The processor 202 may be further configured to update map database 104b and navigation instructions for travelling on the link 108.

The memory 204 of the system 102 may be configured to store a dataset (such as, but not limited to, the set of vehicle features, the incident-related features, the probe data, and the map data) associated with the link 108 and the dispensing vehicle 110. In accordance with an embodiment, the memory 204 may include processing instructions for processing the set of vehicle features. The dataset may include real-time data and historical data, from service providers.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry may be configured to control one or more functions of one or more I/O interface 206 elements through computer program instructions (for example, software and/or firmware) stored on a memory 204 accessible to the processor 202.

In some embodiments, the processor 202 may be configured to provide Internet-of-Things (IoT) related capabilities to users of the system 102 disclosed herein. The IoT related capabilities may in turn be used to provide smart city solutions by providing real time risk value, big data analysis, and sensor-based data collection by using the cloud based mapping system for providing accurate navigation instructions and ensuring driver safety. The I/O interface 206 may provide an interface for accessing various features and data stored in the system 102.

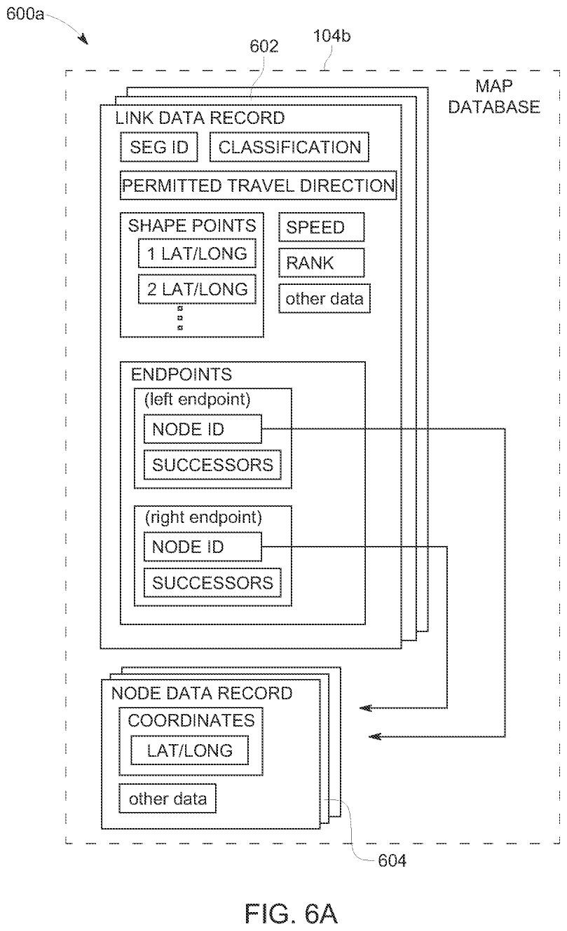

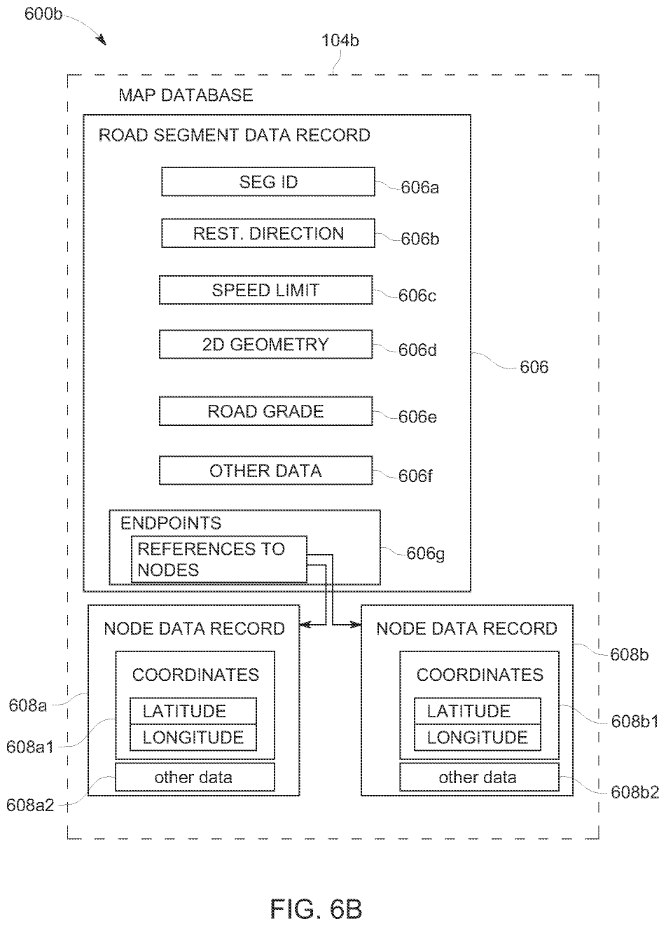

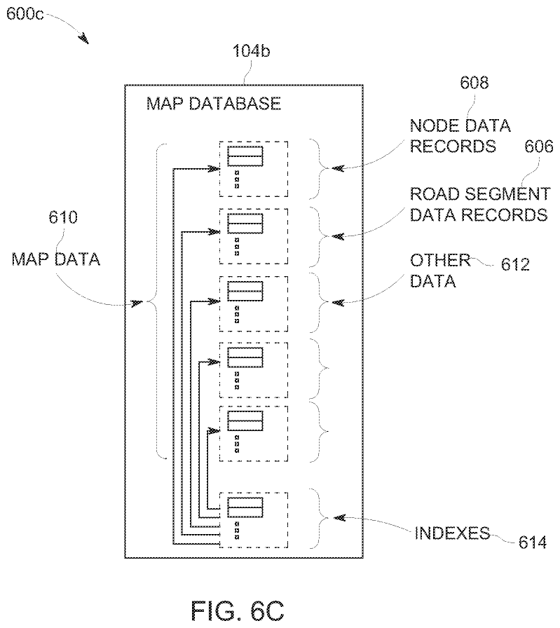

FIG. 6A shows an exemplary format of map data 600a stored in the map database 104b according to one or more example embodiments. FIG. 6A shows a link data record 602 that may be used to store data about one or more lane marking data (referred to as feature links, hereinafter) related to intersection connected links stored in the map database 104b. The link data record 602 has information (such as “attributes”, “fields”, etc.) associated with it that allows identification of an intersection associated with a link and/or the geographic positions (e.g., the latitude and longitude coordinates and/or altitude or elevation) of two intersections. In addition, the link data record 602 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the intersections which correspond to intersections at the ends of a road portion or link represented by the link record, the street address ranges of the roadway portion represented by the link record, the name of the link, and so on. The various attributes associated with a link may be included in a single data record or are included in more than one type of records which are referenced to each other.

Each link data record that represents other-than-straight road segment may include shape point data. A shape point is a location along a link between its endpoints. To represent the shape of other-than-straight roads, the mapping platform 104a and its associated map database 104b developer selects one or more shape points along the other-than-straight road portion. Shape point data included in the link data record 602 indicate the position, (e.g., latitude, longitude, and optionally, altitude or elevation) of the selected shape points along the represented link.

Additionally, in the compiled geographic database, such as a copy of the map database 104b that is compiled and provided to a user interface, there may also be a node data record 604 for each intersection. The node data record 604 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 6B shows another format of the map data 600b stored in the map database 104b according to one or more example embodiments. In the FIG. 6B, the map data 600b is stored by specifying a road segment data record 606. The road segment data record 606 is configured to represent data that represents a road network. In FIG. 6B, the map database 104b contains at least one road segment data record 606 (also referred to as “entity” or “entry”) for each road segment in a geographic region. In an example, a road segment may correspond to a link in a road network.

The map database 104b that represents a geographic region also includes a node database record (depicted as, a node data record 608a and a node data record 608b) (or “entity” or “entry”) for each intersection associated with the at least one road segment shown by the road segment data record 606. (The terms “intersection” and “segments” represent only one terminology for describing these physical geographic features and other terminology for describing these features is intended to be encompassed within the scope of these concepts). Each of the node data records 608a and 608b may have associated information (such as “attributes”, “fields”, etc.) that allows identification of the road segment(s) that connect to it and/or its geographic position (e.g., its latitude and longitude coordinates).

FIG. 6B shows some of the components of the road segment data record 606 contained in the map database 104b. The road segment data record 606 includes a segment ID 606a by which the data record can be identified in the map database 104b. Each road segment data record 606 has associated with it information (such as “attributes”, “fields”, etc.) that describes features of the represented road segment. The road segment data record 606 may include data 606b that indicate the restrictions, if any, on the direction of vehicular travel permitted on the represented road segment. The road segment data record 606 includes data 606c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day. The static speed limit is the sign posted explicit speed limit for the road segment, or the non-sign posted implicit general speed limit based on legislation.

The road segment data record 606 may also include data 606d indicating the two-dimensional (“2D”) geometry or shape of the road segment. If a road segment is straight, its shape can be represented by identifying its endpoints or intersections. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 606 also includes road grade data 606e that indicate the grade or slope of the road segment. In one embodiment, the road grade data 606e include road grade change points and a corresponding percentage of grade change. Additionally, the road grade data 606e may include the corresponding percentage of grade change for both directions of a bi-directional road segment. The location of the road grade change point is represented as a position along the road segment, such as thirty feet from the end or intersection of the road segment. For example, the road segment may have an initial road grade associated with its beginning intersection. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 606e includes the road grade change points and an actual road grade value for the portion of the road segment after the road grade change point until the next road grade change point or end intersection. In a further embodiment, the road grade data 606e includes elevation data at the road grade change points and intersections. In an alternative embodiment, the road grade data 606e is an elevation model which may be used to determine the slope of the road segment.

The road segment data record 606 also includes data 606g providing the geographic coordinates (e.g., the latitude and longitude) of the end points of the represented road segment. In one embodiment, the data 606g are references to the node data records 608 that represent the intersection corresponding to the end points of the represented road segment.

The road segment data record 606 may also include or be associated with other data 606f that refer to various other attributes of the represented road segment. The various attributes associated with a road segment may be included in a single road segment record or may be included in more than one type of record which cross-reference to each other. For example, the road segment data record 606 may include data identifying the name or names by which the represented road segment is known, the street address ranges along the represented road segment, and so on.

FIG. 6B also shows some of the components of the node data record 608a and 608b contained in the map database 104b. Each of the node data records 608a and 608b may have associated information (such as “attributes”, “fields”, etc.) that allows identification of the road segment(s) that connect to it and/or geographic position (e.g., its latitude and longitude coordinates). For the embodiment shown in FIG. 6B, the node data records 608a and 608b include the latitude and longitude coordinates 608a1 and 608b1 for corresponding intersection. The node data records 608a and 608b may also include other data 608a2 and 608b2 that refer to various other attributes of the intersections. In some embodiments, the node data records 608a and 608b may be associated with at least one first point and at least one second point, which may be border points of a feature line or lane marking and at least one second line in vicinity of the feature line (or at least one first point) respectively.

Thus, the overall data stored in the map database 106b may be organized in the form of different layers for greater detail, clarity, and precision. Specifically, in the case of high definition maps, the map data may be organized, stored, sorted, and accessed in the form of three or more layers. These layers may include road level layer, lane level layer and localization layer. The data stored in the map database 106b in the formats shown in FIGS. 6A and 6B may be combined in a suitable manner to provide these three or more layers of information. In some embodiments, there may be lesser or fewer number of layers of data also possible, without deviating from the scope of the present disclosure.

FIG. 6C illustrates a block diagram 600c of the map database 104b storing map data or geographic data 610 in the form of road segments/links, intersections, and one or more associated attributes as discussed above. Furthermore, attributes may refer to features or data layers associated with the link-intersection database, such as an HD lane data layer.

In addition, the map data 610 may also include other kinds of data 612. The other kinds of data 612 may represent other kinds of geographic features or anything else. The other kinds of data 612 may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 104b also includes indexes 614. The indexes 614 may include various types of indexes that relate the different types of data to each other or that relate to other aspects of the data contained in the map database 104b.

The data stored in the map database 104b in the various formats discussed above may help in providing precise data for high definition mapping applications, autonomous vehicle navigation and guidance, cruise control using ADAS, direction control using accurate vehicle maneuvering and other such services. In some embodiments, the system 102 accesses the map database 104b storing data in the form of various layers and formats depicted in FIGS. 6A-6C, to retrieve map data 610 or information from the map database 104b. The system 102 may retrieve sensor data, map data 610 and other information relating to road segment and link topology and geometry from the map database 104b.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system comprising:
a memory configured to store computer executable instructions; and
one or more processors configured to execute the instructions to:
obtain a set of vehicle features associated with a dispensing vehicle travelling along a link;
determine a set of risk-related features associated with the link based at least on the set of vehicle features;
obtain map data associated with the link;
based on the set of risk-related features and the map data, determine a risk value for the link; and
update a map database associated with the link, based on the risk value.

2. The system of claim 1, wherein the one or more processors are further configured to:
update navigation instructions for travelling on the link based on the risk value.

3. The system of claim 2, wherein the one or more processors are further configured to:
dynamically determine a risk value for one or more points on the link at predetermined intervals of time based on the set of risk-related features and the map data associated with the link; and
update the navigation instructions based on the risk value of the one or more points on the link.

4. The system of claim 2, wherein the updated navigation instructions include at least one of: an alternative link recommendation or a risk warning message for travelling on the link, when the risk value is more than a predefined threshold.

5. The system of claim 1, wherein the set of vehicle features associated with the dispensing vehicle includes at least one of: a travel route of the dispensing vehicle, dimensions associated with a dispensing opening of the dispensing vehicle, total load of particles carried by the dispensing vehicle, a rate of dispensing of particles through the dispensing opening, or time of travel of the dispensing vehicle.

6. The system of claim 1, wherein the set of vehicle features associated with the dispensing vehicle is determined based on tracking of the dispensing vehicle.

7. The system of claim 6, wherein the tracking of the dispensing vehicle is performed based on at least one of: vehicles travelling along the travel route of the dispensing vehicle, or metadata provided by a third-party server associated with the dispensing vehicle.

8. The system of claim 1, wherein the one or more processors are further configured to:
obtain environment data associated with the link, wherein the environment data includes environmental effect on dispensed particles from the dispensing vehicle; and
determine the risk value for the link, based on the set of risk-related features, the map data, and the environment data.

9. The system of claim 1, wherein the map data includes at least one of: link geometry, speed limit, intersections information, or link conditions.

10. The system of claim 1, wherein the set of risk-related features associated with the link includes at least one of: change in a road condition parameter due to particles dispensed by the dispensing vehicle, change in a driving condition parameter due to the particles dispensed by the dispensing vehicle, or an impact parameter associated with impact of the particles dispensed by the dispensing vehicle on a vehicle on the link.

11. A method comprising:
obtaining a set of vehicle features associated with a dispensing vehicle travelling along a link;
determining a set of risk-related features associated with the link based at least on the set of vehicle features;
obtaining map data associated with the link;
based on the set of risk-related features and the map data, determining a risk value for the link; and
updating a map database associated with the link, based on the risk value.

12. The method of claim 11, the method further comprising:
updating navigation instructions for travelling on the link based on the risk value.

13. The method of claim 12, the method further comprising:
dynamically determining a risk value for one or more points on the link at predetermined intervals of time, based on the set of risk-related features and the map data associated with the link; and
updating the navigation instructions based on the risk value of the one or more points on the link.

14. The method of claim 12, wherein the updated navigation instructions include at least one of: an alternative link recommendation or a risk warning message for travelling on the link, when the risk value is more than a predefined threshold.

15. The method of claim 11, the method further comprising:
obtaining environment data associated with the link, wherein the environment data includes environmental effect on dispensed particles from the dispensing vehicle; and
determining the risk value for the link, based on the set of risk-related features, the map data, and the environment data.

16. The method of claim 11, wherein the set of vehicle features associated with the dispensing vehicle includes at least one of: a travel route of the dispensing vehicle, dimensions associated with a dispensing opening of the dispensing vehicle, total load of particles carried by the dispensing vehicle, a rate of dispensing of particles through the dispensing opening, or time of travel of the dispensing vehicle.

17. The method of claim 11, wherein the map data includes at least one of: link geometry, speed limit, intersections information, or link conditions.

18. The method of claim 11, wherein the set of risk-related features associated with the link includes at least one of: change in a road condition parameter due to particles dispensed by the dispensing vehicle, change in a driving condition parameter due to the particles dispensed by the dispensing vehicle, or an impact parameter associated with impact of the particles dispensed by the dispensing vehicle on a vehicle on the link.

19. A computer programmable product comprising a non-transitory computer readable medium having stored thereon computer executable instructions, which when executed by one or more processors, cause the one or more processors to carry out operations comprising:
obtaining a set of vehicle features associated with a dispensing vehicle travelling along a link;
determining a set of risk-related features associated with the link based at least on the set of vehicle features;
obtaining map data associated with the link;
based on the set of risk-related features and the map data, determining a risk value for the link; and
updating a map database associated with the link, based on the risk value.

20. The computer programmable product of claim 19, the operations further comprising:
updating navigation instructions for travelling on the link based on the risk value.
